(19) United States
(12) Patent Application Publication
(10) Pub. No.: US 2009/0290128 A1
(43) Pub. Date: Nov. 26, 2009

(54) Tiled color filter for a projection system

(75) Inventor: John Barrett George, Carmel, IN (US)

Correspondence Address: Thomson Licensing LLC, P.O. Box 5312, Two Independence Way, PRINCETON, NJ, 08543-5312, US

(73) Assignee: Thomson Licensing

(21) Appl. No.: 12/448,329

(22) PCT Filed: Dec. 21, 2006
(86) PCT No.: PCT/US2006/049056

§ 371 Date: Jun. 17, 2009

(51) Int. Cl. H04N 9/31; G03B 21/14

(52) U.S. Cl. 353/31; 353/84; 348/E09.027

(57) ABSTRACT

A controllable reflecting device having an array of mirrors that is combined with a tiled color filter such that each micro mirror reflects a single primary color is described. The tiled color filter, in the light path between a light source and the mirror array, images one micro mirror wide primary color stripes on the micro mirror array in a repeating sequence (for example RGBRGB etc.). A movable mirror or lens in the optics path between the micro mirror array and a projection screen is moved to displace the image formed by the micro mirror array and projected to the screen such that for each image all pixel positions at the screen sequentially see a micro mirror of each primary color.

### FIELD OF THE INVENTION

The invention is related generally to a projection system, and more particularly to a color filer for a projection system including micro-displays.

### BACKGROUND

Micro-display projection systems using a reflective light engine or imager, such as digital light pulse (DLP) imager, are increasingly utilized in color image or video projection devices (e.g., rear projection television (RPTV)). In an existing projection system, shown in FIG. 1, a light source 10 is provided, in this case a UHP lamp generates white light (i.e., all color spectrums). Light from the light source 10 passes through a color wheel 20 which has a plurality of dichroic filtering elements, each of which allows a light band of one of the colors: blue, green and red to pass through and reflects light of the other colors. The color wheel 20 is rotated so that a temporal pattern of blue, green, and red light bands pass through the color wheel. The color wheel is typically rotated fast enough to create at least one primary color period for each primary color during each frame of a video image. Rotating the wheel faster, or using multiple filter segments for one or more of the primary colors can produce color separation artifacts that allow the viewer to detect the sequential color nature of the display system. For example, color breakup, also called the rainbow effect, is caused by light passing through a rotating color wheel with colors flashing sequentially and appears as a momentary flash of rainbow-like striping typically trailing bright objects when looking quickly from one side of a viewing screen to the other, or when quickly looking away from the viewing screen to an off-screen object. Additionally, color edge effects appearing as a flash of one of the three primary colors in the sequential color light beam at a leading edge of a moving object across the screen may also produce color separation artifacts.

An integrator 30 receives the light band from the light source 10 that is allowed to pass through the color wheel 20 and directs the light band through relay optics 40 into a total internal reflection (TIR) prism 50. The TIR prism 50 deflects the light band onto an imager 60, such as a DLP imager. The imager modulates the intensity of individual pixels of the light beam and reflects them back through the TIR prism 50 and into a projection lens system 70. The projection lens system 70 focuses the light pixels onto a screen (not shown) to form a viewable image. A color video image is formed by rapid successive matrices of pixels of each of the three colors (blue, green, and red) which are blended by the viewer's eye to form a full color image.

Throughout this specification, and consistent with the practice of the relevant art, the term pixel is used to designate a small area or dot of an image, the corresponding portion of a light transmission, and the portion of an imager producing that light transmission.

The DLP imager 60 comprises a matrix of micro-mirrors, moveable between an angle that reflects light through the TIR prism 50 and into the projection lens system 70 and an angle that deflects the light so that it is not projected by the projection lens system 70. Each micro-mirror reflects a pixel of light of a desired intensity depending upon a succession of angles of that particular micro-mirror which in turn are responsive to a video signal addressed to the DLP imager 60. Thus, in the DLP imager 60, each micro-mirror or pixel of the imager modulates the light incident on it according to a gray-scale factor input to the imager or light engine to form a matrix of discrete modulated light signals or pixels.

Existing DLP imagers, however, suffer from several problems. The color wheel wastes light, as the light having the colors that are reflected is typically lost. Also, color separation or break-up artifacts degrade the image quality of the projection system, as described above. As such, a system for reducing color separation or breakup artifacts and/or having improved resolution is needed.

### SUMMARY

The present invention is directed to a controllable reflecting device having an array of mirrors that is combined with a tiled color filter such that each micro mirror reflects a single primary color. The tiled color filter, in the light path between a light source and the mirror array, images one micro mirror wide primary color stripes on the micro mirror array in a repeating sequence (for example RGBRGB etc.). A movable mirror or lens in the optics path between the micro mirror array and a projection screen is moved to displace the image formed by the micro mirror array and projected to the screen such that for each image all pixel positions at the screen sequentially see a micro mirror of each primary color. At the micro mirror array detail in the image is moved to appropriate mirrors such that the displacement of the projected image is canceled and said detail does not move at the screen. The tiles of the tiled color filter are sized to pass maximum light in the most deficient color from the light source, for example red when using a UHP arc lamp. Green and blue filters are optically stopped by reducing their light passing areas in proportions such that at each gray scale level substantially equal flash pulses to all three (3) colors achieve the desired white point. The area of the green and blue filters that does not pass light is made reflective to all colors to aid in light recapture.

### BRIEF DESCRIPTION OF THE DRAWINGS

The invention will now be described with reference to the accompanying figures of which:

FIG. 1 shows a diagrammatic view of an existing digital light pulse (DLP) projection system;

FIG. 2 shows a diagrammatic view of a projection system according to an exemplary embodiment of the invention;

FIG. 3 shows a sample color tile layout according to the invention;

FIG. 4 shows the spectra of lamp emission and filter transmission; and

FIG. 5 shows the fixed viewing window at the screen.

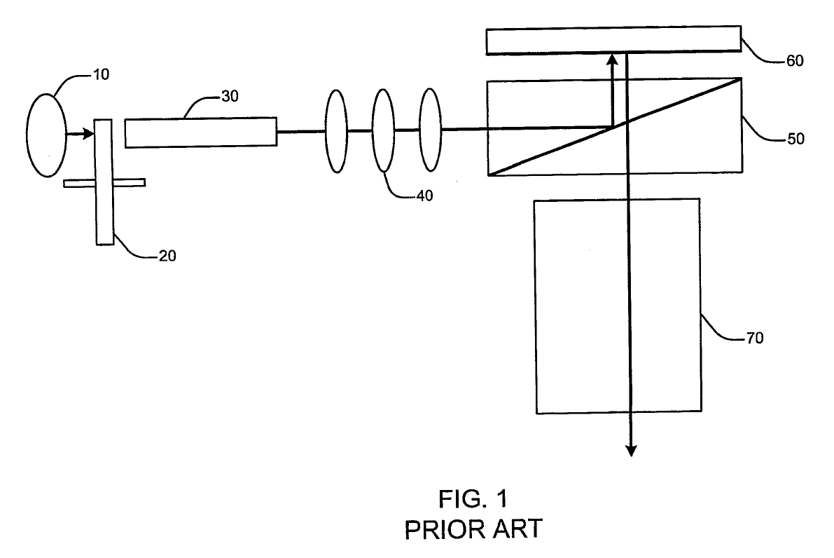

### DETAILED DESCRIPTION

The present invention provides a color projection system, such as for a television display, for projecting a video image with enhanced resolution and/or reduced mechanical motion of the projection system due to shifting of a pattern of monochromatic pixels a controllable reflecting device having an array of mirrors that is combined with a tiled color filter such that each micro mirror reflects a single primary color. The tiled color filter, in the light path between a light source and the mirror array, images one micro mirror wide primary color stripes on the micro mirror array in a repeating sequence (for example RGBRGB etc.). A movable mirror or lens in the optics path between the micro mirror array and a projection screen is moved to displace the image formed by the micro mirror array and projected to the screen such that for each image all pixel positions at the screen sequentially see a micro mirror of each primary color. At the micro mirror array detail in the image is moved to appropriate mirrors such that the displacement of the projected image is canceled and said detail does not move at the screen. The tiles of the tiled color filter are sized to pass maximum light in the most deficient color from the light source, for example red when using a UHP arc lamp. Green and blue filters are optically stopped by reducing their light passing areas in proportions such that at each gray scale level substantially equal flash pulses to all three (3) colors achieve the desired white point. The area of the green and blue filters that does not pass light is made reflective to all colors to aid in light recapture.

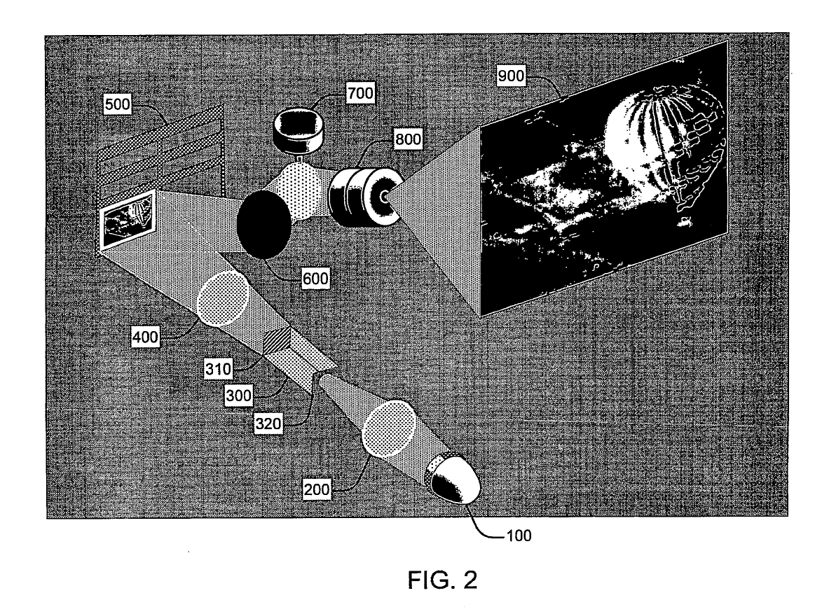

FIG. 2 is a diagrammatic view of a projection system according to an exemplary embodiment of the invention. Light from arc lamp 100 passes through condensing lens 00 and is focused into the transparent aperture in recapture mirror 310. Recapture mirror 310 is on the input surface of integrating rod 300. The interior surfaces of integrating rod 300 are total reflecting. The light reaching the tiled color filter 320 is uniform across the surface of tiled color filter 310.

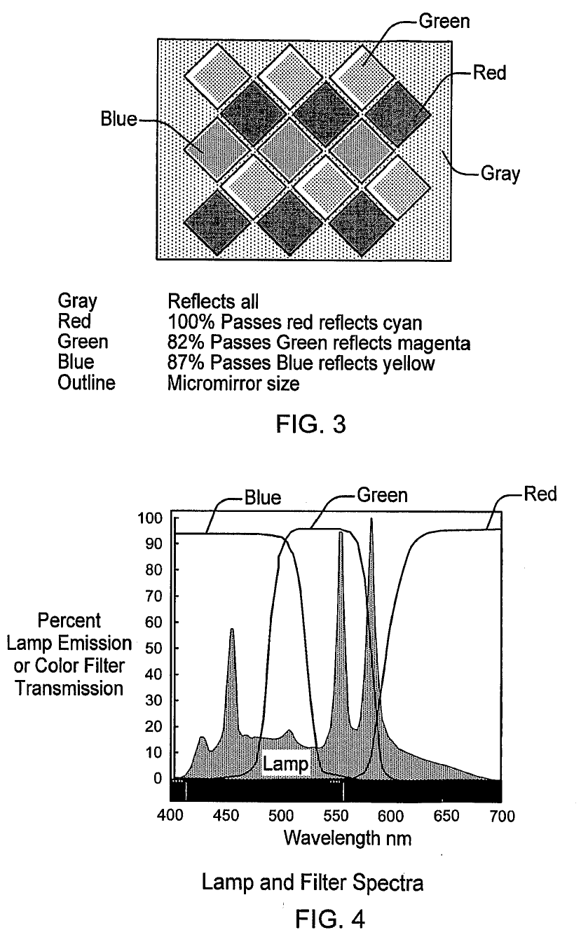

The design detail of tiled color filter 310 is shown in FIG. 3 and will be described below. Relay optic 400 forms an image of tiled color filter 310 on Digital Micro-mirror Device (DMD) 500 such that each micro-mirror is lit by only one color. The image from DMD imager 400 is reflected by fold mirror 600 and image shifting mirror 700 before passing through projection lens 800 and appearing on screen 900.

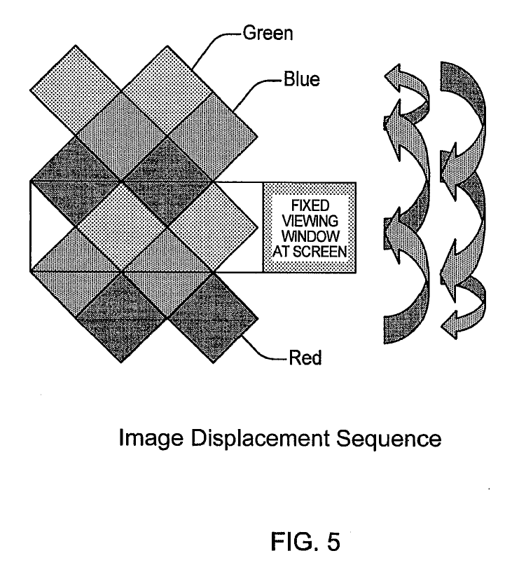

Fold mirror 600 corrects reversal of the image on screen 900. Image shifting mirror 700 is rotated around its vertical axis by the attached actuator so that the image on screen 900 moves in one pixel or one half pixel steps as shown in FIG. 5. For each image, each pixel on screen 900 is lit by all 3 colors sequentially. To do this, each pixel must see 3 different micro mirrors, one for each primary color.

The images of the micro-mirrors are moved into position on screen 900 using image shifting mirror 700. Simultaneously, to prevent blurring, the detail in the image must be moved so as to cancel the shift due to image shifting mirror 700. After rendering a color image in a first position on screen 900 image shifting mirror 700 moves the image one half pixel and renders a second color image. This one half pixel displacement allows additional detail to be added without extra micro-mirrors.

FIG. 3 shows a sample color tile layout according to the invention. For simplicity, the tiled color filter pattern is shown projected on the grid of the DMD imager. The actual physical size of the filter may be either larger or smaller than the imager. Any size difference is corrected via the relay optic.

In this example the tiled color filter 310 is intended to replace a color wheel with three segments in 180 degrees consisting of red 67 degrees, green 55 degrees and blue 58 degrees.

In one illustrative example, the red filter size is 100% of the active mirror area, the green filter size is 55/67 or 82% of the active mirror area and the blue filter is 58/67 or 87% of the active mirror area.

The tiled color filter 310 may be dichroic so as to be made up of thin layers on a glass substrate. Each color filter area efficiently passes the desired color and reflects the complement color.

The light beam passing through or reflecting from the tiled color filter 310 is very high energy. Losses cause heating and possible damage. As such, the remainder of the filter area that is unused to pass light may be made reflective to all colors. This protects the tiled color filter 310 from beat losses and adds to the light rays available for light recapture.

FIG. 4 shows the spectra of lamp emission and tiled color filter 310 transmission. The lack of red lamp energy is easily seen.

In FIG. 5 the fixed viewing window at the screen sees various colored micro-mirrors sequentially due to the action of image shifting mirror 700. The yellow arrows show the sequence of whole pixel and half pixel steps. Only one axis of mirror rotation is required.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A projection system, comprising:
an integrator with an output end;
an array of micro mirrors;
a tiled color filter at the output end of the integrator, wherein a portion of the tiled color filter projects one micro mirror wide red, blue and green stripes on the micro mirror array in a repeating sequence; and
an image shifting element to displace an image formed by the micro mirror array and project it toward a screen so a pixel position at the screen sequentially see a micro mirror of each primary color.

2. The projection system of claim 1 wherein the image shifting element is a mirror.

3. The projection system of claim 1 wherein the tiled color filter is dichroic.

4. The projection system of claim 1 wherein the image shifting element is a lens.

5. The projection system of claim 1 wherein each red tile of the tiled color filter has a size of about 100% of the micro mirror width.

6. The projection system of claim 1 wherein each green tile of the tiled color filter has a size of about 82% of the micro mirror width.

7. The projection system of claim 1 wherein each blue tile of the tiled color filter has a size of about 87% of the micro mirror width.

8. The projection system of claim 1 wherein the remainder of the tiled color filter area that is unused to pass light may be made reflective to red, blue and green colors.
